(19) United States
(12) Patent Application Publication
(10) Pub. No.: US 2006/0089874 A1
(43) Pub. Date: Apr. 27, 2006

(54) Generating income for a beneficiary organisation and loyalty points using purchases by a consumer

(76) Inventors: Christian D. Newman, London (GB); Ben Simon George, London (GB)

Correspondence Address: STITES & HARBISON PLLC, 1199 NORTH FAIRFAX STREET, SUITE 900, ALEXANDRIA, VA, 22314, US

(21) Appl. No.: 10/970,651

(22) Filed: Oct. 22, 2004

(51) Int. Cl. G06Q 30/00

(52) U.S. Cl. 705/14

(57) ABSTRACT

The present invention relates to computer implemented loyalty or loyalty provider methods and systems for generating income for a beneficiary organisation and/or loyalty points using purchases by an individual, company or other entity (generally referred to as a consumer). In another aspects, it also relates to a code carried by a signal or held on a carrier medium which provides a display element and/or webpage for a consumer. Embodiments of the invention link both loyalty points (or other rewards) which are earned by the consumer and donation to a beneficiary with any goods or services purchased and provide a graphical display for potential and accumulated loyalty points and/or donation.

### FIELD OF THE INVENTION

The invention relates to online fundraising over a distributed network, involving consumers who support a beneficiary organisation, such as a football or other sport club, charity, church or other organisation benefiting from a loyal supporter or affinity group.

### BACKGROUND OF THE INVENTION

In conventional loyalty schemes, some fixed reward, such as a discount on a given product or a fixed number of reward points, is offered to consumers who make repeated or high value purchases with a given retailer or affiliated group of retailers. In more advanced loyalty schemes, offers of rewards can be personalized to a given consumer's profile which includes marketing data and their individual purchasing history.

In the case of reward points, consumers accumulate loyalty status, which has a monetary value to those running the loyalty scheme. Loyalty schemes often allow the consumer to trade their loyalty status against future purchases, and therefore the reward points are in effect acting as a currency. The systems can be available over the internet and operated in conjunction with internet shopping pages (see for example US2003/220834).

The business purpose of reward schemes is to increase the number and value of consumer transactions with participating merchants. Transactions under some of the more flexible schemes could potentially be modified to benefit instead one or more selected third party organisations or beneficiary organisations, which could conceivably also be individuals to which the consumer already has loyalty and/or to which the consumer wishes to make a charitable donation. For example, a credit card could potentially offer loyalty points to the consumer as an incentive or alternatively benefit a charity in that a percentage of consumer spend is donated by the credit card company.

However, there is no scheme that allows and even possibly actively encourages the consumer to spend money and gain loyalty points, but also potentially to the benefit of a beneficiary organisation.

### SUMMARY OF THE INVENTION

The present invention relates to loyalty or loyalty provider methods and systems for generating income for a beneficiary organisation and/or loyalty points using purchases by an individual, company or other entity (generally referred to herein as a consumer or supporter). In another aspect, it also relates to a code carried by a signal or held on a carrier medium which provides a display element and/or webpage for a consumer. Embodiments of the invention link both loyalty points (or other rewards) which are earned by the consumer and donation to a beneficiary with any goods or services purchased.

According to one aspect of the invention there is provided a computer implemented method and system of generating income for a beneficiary organisation and loyalty points using purchases by a consumer, including the steps of, or functionality for: when a purchase is made, allocating the consumer corresponding loyalty points and a separate generated amount of income (or donation) to be transferred to the beneficiary organisation; accumulating the consumer's allocated loyalty points and donation with those of purchases already made; and generating a visual accumulated indicator of the consumer's accumulated loyalty points and/or donation for display to the consumer over a communications network.

In this aspect of the invention, both loyalty points and a donation to a beneficiary are provided by a single loyalty scheme. Moreover, a display of points and/or donation is provided for the consumer.

Preferably, the purchase is made over the communications network. In this and following aspects, the method and system may also provide include steps/functionality allowing the consumer to make the purchase.

According to another aspect of the invention there is provided a computer implemented method and system for generating income for a beneficiary and/or loyalty points under a loyalty scheme using purchases by a consumer, including the steps of or functionality for using loyalty points and/or donation amounts allocated according to the purchases by: whenever a potential purchase decision is indicated by the consumer, generating for display to the consumer a real-time visual potential indicator of potential loyalty points and/or potential income that would be awarded if the purchase were made; and whenever a purchase is made, awarding the consumer loyalty points and/or a separate generated donation to be transferred to the beneficiary organisation; and generating for display to the consumer in real-time an accumulated visual indicator of his accumulated loyalty points and/or donations.

In this aspect, the consumer is provided with an incentive to make a potential purchase by demonstration of the rewards available.

Use herein of the term “functionality” is taken to include the necessary software and/or hardware and/or firmware for provision of the method steps. Usually this will include a suitable programming of the computer system, a database application (or a plurality of linked databases) and one or more servers.

Preferably the method includes display over a communications network of the visual potential and accumulated indicators.

The visual accumulated and/or potential indicators may be purely text but preferably comprise a graphical display element.

The visual or graphical indicator referred to herein may be formed from a code or program portion embodied in a signal downloadable from the communication network or stored on a data storage medium. For example, it may comprise part of the code providing a webpage when read by a browser or an image such as a GIF or JPG image or graphic, such as vector graphics instructions which are rendered by the consumer device. It may include text.

A key element of the loyalty scheme in this aspect of the invention is device independence. Put simply, the more ways consumers can shop and simultaneously access their rewards data the better. This implies that in order to minimize the effort in supporting so many types of device, as much processing as possible should take place on the server side rather than client side of a networked transaction. Indeed, some client devices may have extremely limited local processing power. The basic requirements of a loyalty device are that it can use a communication network and has a display of some sort. It could for example be a PC, laptop, computer notebook, mobile phone, PDA or a loyalty card with a screen. The one client side element that is key however is the visual indicator, or graphical indicator. Any visual indicator may be provided, such as lettering or numerals. However, a graphical indicator is preferred. The graphical indicator may include a bar chart, graph, pie chart, diagram whose size varies with purchases etc. It is usually presented as a reward bar, which may be an interactive shopping tool.

The Reward Bar is a scaleable visual indicator comprising one or more blocks, the size of which (normally in one dimension e.g. in length or height) corresponds to the loyalty information for a consumer. It can be preferably be displayed simultaneously and consistently on a variety of devices and indicates a consumer's current (loyalty) status. The status may include both loyalty points and donation level, (as a double bar) or just one may be provided.

For example, one form of reward bar is a horizontal double bar, one bar representing loyalty points and the other donation level. Each bar is divided into an accumulated block starting from the left and potential block showing additional parts/donation that could be obtained by making a purchase highlighted on a shopping web page. The potential block is added to the right end of the accumulated block so that the right hand end of the bar indicates the sum of accumulated and potential. In another example, the double bar is vertical.

One important feature of embodiments of the reward bar is that ist can be used interactively with another shopping tool, such as a web page. It can show the increase in loyalty status a consumer can potentially obtain by completing a particular shopping transaction. When the consumer expresses an interest in a product (for example by clicking on a product on a web page or just moving a mouse over the product, holding a smart card against an electronically identified product or in any other way), the reward bar changes to the “active browse state”. This reflects the potential rewards attainable by purchasing the product. Thus, whenever a potential purchase decision is indicated, the consumer sees a real-time visual potential indicator.

The appearance and functionality of the reward bar or other visual indicator for a given consumer can be dynamically varied depending on the capabilities of the user agent (eg. browser) running in the consumer's loyalty device. The principal factors are the resolution and colour depth (if any) of the display screen.

Preferably, the visual indicator includes both a visual accumulated indicator having one display attribute such as colour or shading, and a visual potential indicator having a different second display attributes. For example, the potential indicator may flash on a display and the accumulated indicator may be shown permanently or the potential could be a paler colour or have lighter shading than the accumulated indicator.

Preferably, the reward bar or other graphical indicator has labelling, such as numbering in points and/or a currency to give the consumer a more accurate impression of loyalty points/donation level. Preferably, the potential indicator is displayed as an addition following on from the accumulated indicator (e.g. along the same axis starting from the furthest extent of the accumulated indicator) so that the consumer can see the total of the accumulated and potential points and or donations.

Moreover, the display element may be adaptable for use with a variety of consumer devices, whilst remaining recognisable. For example, a simple device might show a display element of a single individual loyalty point bar having two blocks, for accumulated and one for potential extra loyalty points, with some labelling; a more complex device might additionally show a double bar with a second matching donation bar having different numbering for donation levels and additional text. A third further bar could also be provided with other information, for example, to show an achievement level such as the total donation raised by all the consumers in each month. The display element may also contain target related information. Alternatively or additionally to the third bar mentioned above, a further bar could be provided to show the level of points at which the user will qualify for a prize, such as a free ticket to a football match. The donation bar or bars could be set to zero at the beginning of each month. Preferably the loyalty point bar level is adjusted only when loyalty points are added or redeemed.

The bar can be automatically scaled (and numbered) according to the actual figures for donation amount and/or loyalty points accessed over the communication network.

For example, it can be scaled to take up about half the available horizontal extent of the relevant display area.

The loyalty method and system of invention embodiments is thus advantageous in the way it makes unified use of varying hardware devices (conventional magnetic stripe cards, network enabled smartcards, mobile phones, PDAs and general internet capable computers) to build a reward system and to display the recognizable reward bar.

The visual indicator may be advantageously generated securely in real time from a set of central servers managed by the loyalty provider. The status of the indicator may be derived from a variety of inputs including one or more of the consumer's identity and marketing group, the consumer's purchasing history, the promotional data for the product being viewed and real time offers available for redemption. This generates a “balance state” of the reward bar.

Embodiments of the invention link consumers with beneficiaries over a communication network. There are several other entities that may be linked to each other in the communication network to provide the loyalty system and a list of possible participants is given below:

i) consumers or supporters—members of the public who register with the system and purchase products;

ii) beneficiaries—an individual or organisation such as a church, charity or football club that inherently attracts the loyalty of consumers;

iii) merchants—companies who sell products to the consumers. They may be explicitly approved to be associated with the given beneficiary's brand and offer configurable rewards to consumers;

iv) loyalty provider—the company that provides and/or hosts part or all of the technology solution which runs the loyalty scheme or framework;

v) banks—settlement with each merchant bank and beneficiary's bank may be made following settlement of the consumer's payment instructions with the loyalty provider's bank.

In one embodiment, the loyalty provider computer method and system creates shopping webpages for display of goods available from one or more merchants under the loyalty scheme and in this case the potential and accumulated indicators may be provided as part of the shopping webpage. In a preferred embodiment, the method and system allow purchase of goods from a plurality of merchants, advantageously as a single transaction (possibly using a virtual shopping basket).

In another embodiment, the loyalty provider computer method and system creates a signal carrying code which provides a display element including the potential and accumulated indicators for inclusion in shopping webpages hosted by one or more merchants offering goods under the loyalty scheme.

In another aspect of the invention there is provided a merchant computer system for connection to a loyalty provider computer system over a communication network, wherein the merchant system is operable to provide information on purchases for display to a consumer over the network, calculate loyalty information corresponding to a potential purchase indicated by the consumer and/or retrieve such information from the loyalty provider system; and provide this loyalty information to the consumer over the network in real time for any potential purchase decision.

Preferably, the loyalty information calculated or retrieved by the merchant system includes a graphical or visual display element showing potential loyalty points and/or donations to a beneficiary.

Embodiments of the invention are advantageous in that the system has been designed such that sophisticated promotions can be created by merchants rather than by the loyalty scheme provider. For example, in a standard supermarket loyalty scheme the supermarket offers any customer reward points for purchasing certain products. In the model of this aspect of the invention, it would be the merchant selling the product that allocates the reward points or decides not to allocate reward points. Additionally, the merchant can vary the reward for customers loyal to their own particular products. For example, the merchant may access the loyalty provider system (for example using a merchant site hosted by the loyalty provider) to set up reward point levels and/or special checks on product combinations.

In fact any element of marketing data that is known about the customer in the system can be used at the basis for offering selective rewards, either by the loyalty provider or by the merchant.

The loyalty points may be in direct numerical relationship to the donation level but are preferably calculated separately. Preferably, the system keeps track of consumer purchase history. Ideally one or more elements of marketing data that are known about the customer in the loyalty provider computer system can be used as the basis for offering selective rewards, either by the loyalty provider or by the merchant.

Advantageously, the donation and/or loyalty points are determined individually for each purchase (item) according to the parties involved.

The method and system may allow conversion of the loyalty points to a donation at a fixed or variable “exchange rate”.

In preferred embodiments, the donation level is determined as a percentage of the purchase price for each purchase and a percentage of the purchase price is also allocated to the loyalty provider as payment for provision of the loyalty scheme. Advantageously, the percentages allocated to the donation and loyalty provider are defined according to the merchant, the beneficiary organisation specified (if any) and the product class.

Preferably, the consumer makes payment for the purchase to a loyalty provider who manages the loyalty scheme and the loyalty provider settles with the beneficiary organisation and merchants providing the goods periodically, wherein settlement to the merchant is made once a currency value of a consumer's redeemed loyalty points, a loyalty scheme charge and any donation have all been deducted.

Since the scheme has a central loyalty provider, it can be made to adapt to the consumer's wishes. For example, it can be designed so that loyalty points can be redeemed against any purchase from any merchant made under the loyalty scheme alone, or in conjunction with monetary payment. Thus the consumer can have sole control of the number of loyalty points redeemed and can redeem them at any time, without any minimum level being attained. Thus points can be used as a part payment together with money in any purchase under the scheme. The use of loyalty points may be invisible to the merchant, so that the merchant is unaware of the payment method.

The loyalty provider and/or beneficiaries and/or merchants can use the system in a number of flexible ways to serve the consumer or increase profit margins. For example, the consumers' accumulated donations may be used to generate a consumer league table for display over a communications network.

This allows the beneficiary to stimulate purchases. The effect can be enhanced by awarding prizes to top donators in the table. Similarly, the beneficiary can offers prizes to any consumer who achieves over a certain level of points. The prizes could be, for instance, tickets to a special enclosure at a football match. Such offers will reduce the cash benefit to the beneficiary, but aim to increase consumer spend.

In another aspect, the invention relates to signal carrying code which when read by a browser creates a consumer webpage used for generating income for a beneficiary organisation and loyalty points using purchases by a consumer, wherein the webpage, when accessed, allows award to the consumer of loyalty points and a donation to the beneficiary organisation corresponding to the purchase; and display to the consumer of a visual indicator showing accumulated loyalty points and/or income generated; and optionally redemption of the loyalty points by the consumer. The invention in this and the following aspects also relates to a data storage medium storing this code.

In yet another aspect, the invention relates to signal carrying code which when read by a browser creates a consumer webpage allowing display of loyalty points for a consumer and/or donations for a beneficiary organisation according to purchases by the consumer, wherein the webpage, when accessed, allows retrieval from a server of accumulated visual indicator showing the consumer's previously accumulated loyalty points and/or donations; display of the accumulated visual indicator; highlighting of a potential purchase by the consumer; retrieval from a server of a potential visual indicator showing potential loyalty points and/or donations; and display of the accumulated and potential visual indicators.

Preferably, the webpage allows acquisition of a purchase by a consumer.

In a further aspect, the invention relates to signal carrying code which when rendered (or read by a browser), produces a display element for use on a consumer device with a display and a connection in use to a communication network through which connection data on purchases and associated loyalty points and donation amounts can be accessed, wherein the display element includes a visual indicator of the consumer's loyalty points and/or donation generated, the visual indicator being downloadable from the communication network. Such a display element may be suitable for simpler devices or may be inserted within a webpage.

The invention further provides a method of producing a signal as defined hereinbefore for provision to a consumer over a communications network and a computer program product tangibly embodied in an information carrier to control operation of a data processing apparatus and thereby provide the system as defined hereinbefore.

In a final aspect, the invention relates to a computer program product tangibly embodied in an information carrier (such as a signal or storage medium) which, when run on a data processing apparatus having a database product and an application server carries out the method as defined hereinbefore.

### DETAILED DESCRIPTION OF THE INVENTION

The invention will now be further described with reference to exemplary embodiments shown in the figures in which:

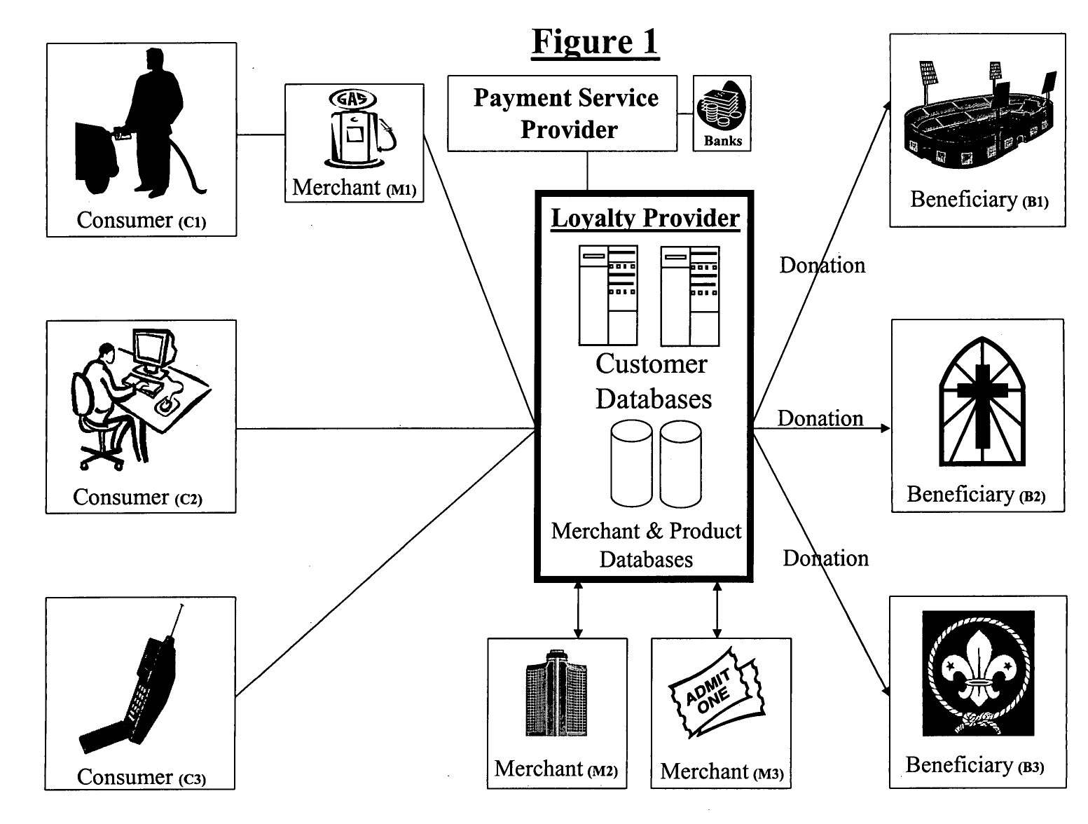

FIG. 1 is a schematic diagram of entities in the loyalty scheme;

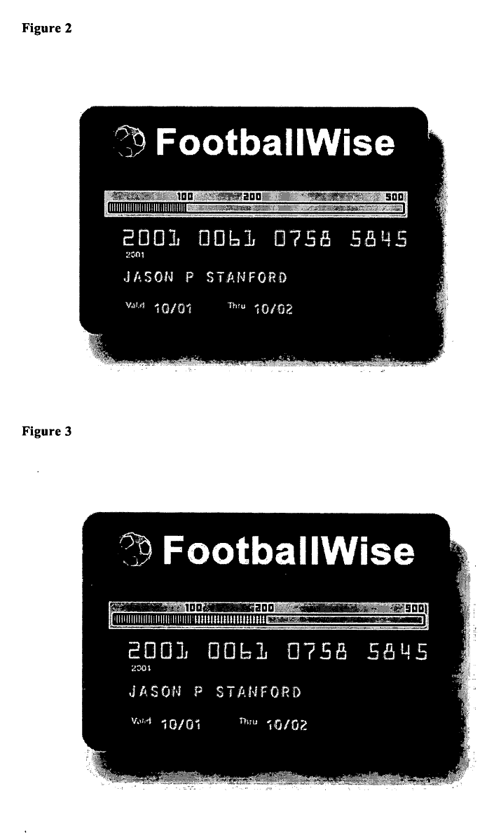

FIGS. 2 & 3 show a consumer device in the form of a wireless reward card;

FIGS. 3 & 5 shows an insert forming part of a webpage;

FIG. 6 shows a WAP page;

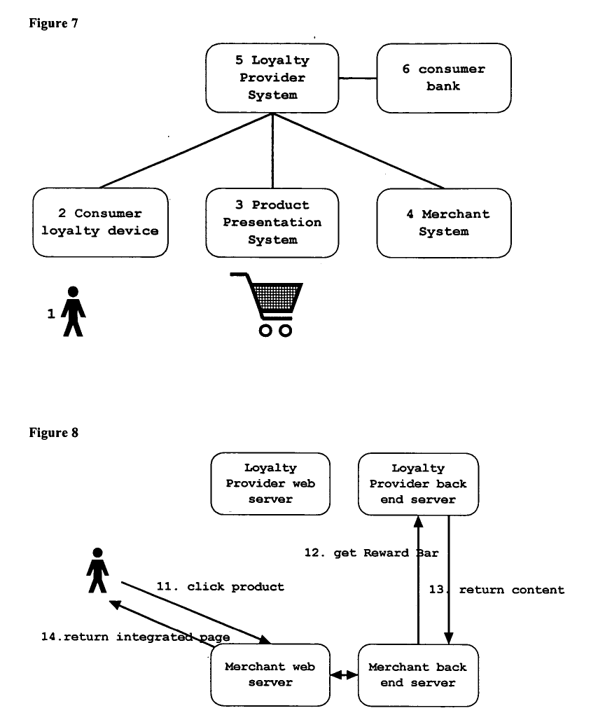

FIG. 7 shows entities involved in a point of sale transaction;

FIG. 8 shows a flow chart of information in a merchant presentation point of sale transaction;

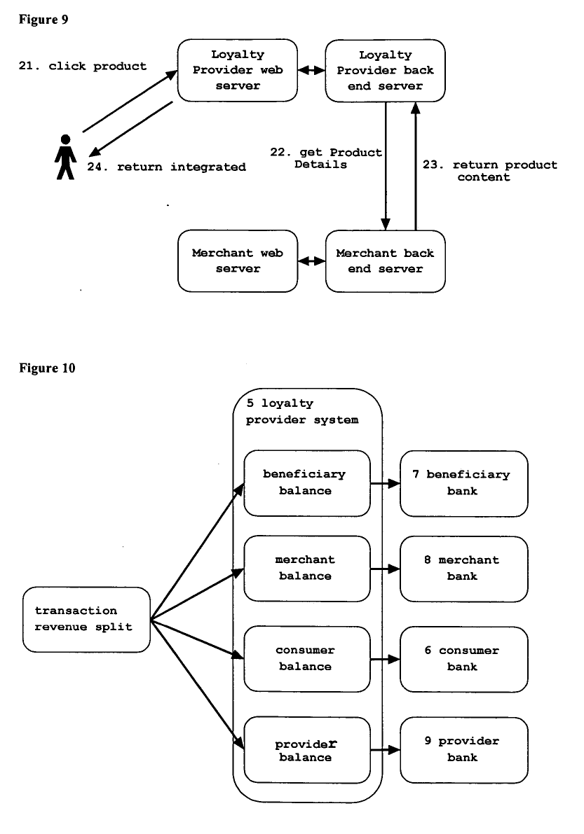

FIG. 9 shows a flow chart of information in a loyalty provider presentation point of sale transaction;

FIG. 10 shows entities involved in a back office transaction;

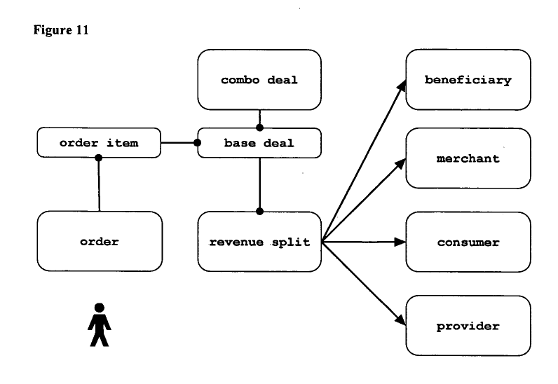

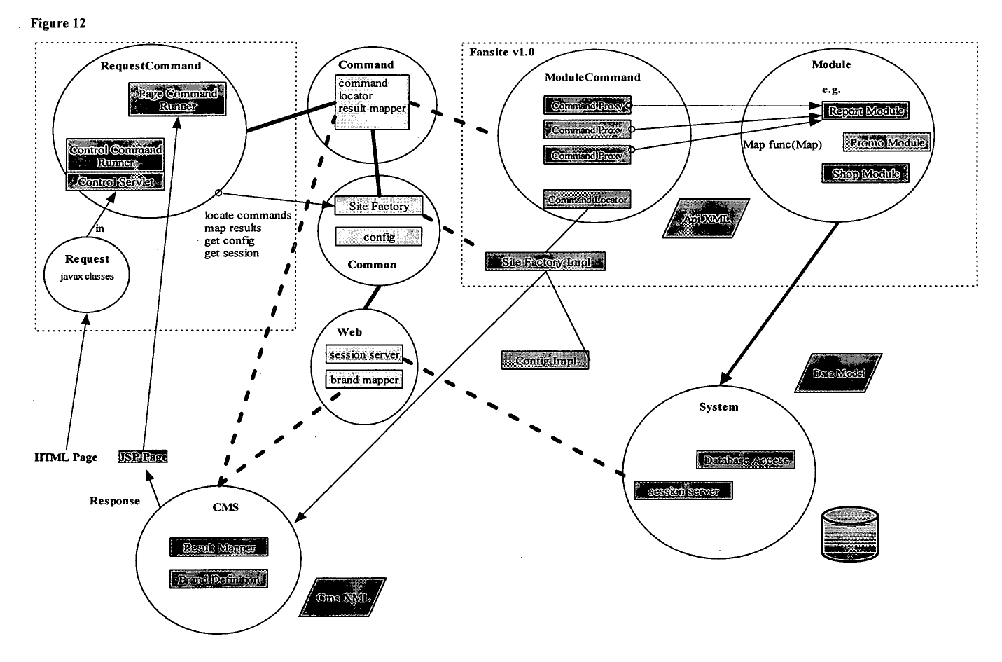

FIG. 11 shows a revenue split mechanism; and

FIG. 12 shows a possible execution architecture.

### OVERVIEW OF LOYALTY SCHEME ENTITIES

FIG. 1 gives an overview of the entities involved in the invention and their links over a communication network (for example, the Internet and a telephone network). It should be noted, however, that beneficiary may also act as a merchant (for example a football club that sells products over the internet). Moreover, the loyalty provider may be merchant and host a number of different web sites, for beneficiaries, merchants and consumers. For example, the loyalty provider may host:

a) one or more general own brand or affiliated shopping sites as a merchant (e.g. footballshop.com);

b) brand label site (e.g. high traffic club site for a merchant beneficiary, Footballclub.com);

c) merchant site (used by merchants to manage their products, view their sales, communicate with customers, etc e.g. merchant.loyaltyprovider.com);

d) beneficiary site (used by beneficiaries to view the transactions that have generated them revenue e.g. footballclub.loyaltyprovider.com); and

e) admin site (used only by loyalty provider football club employees).

The entities may be further linked via their networks as appropriate (as shown between the loyalty provider and merchant M1). For example, there may be EDI type replication from a merchant product catalogue database e.g. via a back office connection to the loyalty provider database. Each consumer may have one or more devices that access the Internet and display information. The consumer may access a web page generated by the loyalty provider or the merchant using a loyalty device. The web page includes product information from one or more merchants. It also includes a display element showing accumulated points and donation which is generated by the loyalty provider. Alternatively, if the device is a more simple one, it may access modified, cut-down information from the loyalty provider or merchant over the Internet or another link which merely enables generation of a basic display element.

When the consumer indicates interest in a product (by highlighting or clicking on it or placing a simple device adjacent to a product), a resultant signal is sent to the merchant and/or loyalty provider and potential loyalty points and/or donation are returned in real time and displayed as an addition to the accumulated display but with a different display attribute. If the consumer proceeds to purchase, the extra points are accumulated (the display attribute of the potential indicator changes to that of the accumulated points). If not, the potential is deleted when the consumer is no longer indicating interest.

In the case of a purchase, payment by the consumer may be made over the communication network, probably via an intermediary or payment service provider. Preferably, payment is to the loyalty provider, who will settle with the merchant after a certain elapsed period of time or once the consumer has indicated satisfaction with the purchase. Transfer of donations to the consumer's selected beneficiary may be on a monthly basis. Redemption of loyalty points can be against purchases from any merchant participating in the loyalty scheme, transfer to donation or any other suitable method, such functionality being available on the loyalty provider and/or merchant website. The scheme can be flexible in that no particular level of points is required before redemption, the points can be used alone or with other payment to make up the purchase price and in that points can be used for purchases from merchants even if that merchant does not award points. Thus the payment method (points and/or money) can be invisible to the merchant.

Although the non-currency tender referred to throughout this disclosure is frequently referred to as loyalty points, or reward points this invention is not so limited. It should be understood that the expressions include any type of non-currency tender, such as coupons, frequent flyer miles, incentive awards, frequency awards, and the like.

FIGS. 2 to 6 show embodiments of consumer devices, each having a display which can present a display element as described previously.

Wireless Reward Card

FIG. 2 shows a loyalty device which may be embodied as a wireless reward card with LCD display for use in a retail store (merchant) with RFID tagging. Such tags are short range radio frequency product tags which are being used increasingly in retail outlets for more efficient supply chain management and product tracking. In this embodiment, the card has a display which can be updated wirelessly. Alternatively, a card could be provided with a display which is updated only when a purchase takes place, by “swiping” it through a terminal of a retail establishment participating in the loyalty scheme.

In FIG. 2, the card display element on card is shown in the accumulated balance state. In this example, the consumer can see at a glance from a graphical indicator having a shaded block representing loyalty points that their current reward point balance is 100. This information is provided from a loyalty provider server over a wireless Internet link.

If the consumer passes within range of a product, say a leather jacket, which is RFID tagged, the reward card detects the product id and sends it to the loyalty server which returns the current potential reward point level offers for this product. Other mechanisms are also possible for returning the information. The level may be varied by the merchant, for example for most consumers, the merchant may not offer any loyalty points for the purchase of this leather jacket. However, if the merchant has set-up this product to have a birthday discount and, if it is the consumer's birthday today, the consumer will receive an additional 100 reward points if he purchases this product.

In FIG. 3 the card is shown in the active browse state. The potential increase in the consumer's regard level is displayed as a different pattern (display attribute) on the LCD strip display.

The consumer can now see:

the current reward point balance: and

the increase in reward point balance that the current potential purchase would generate.

Web Page Use

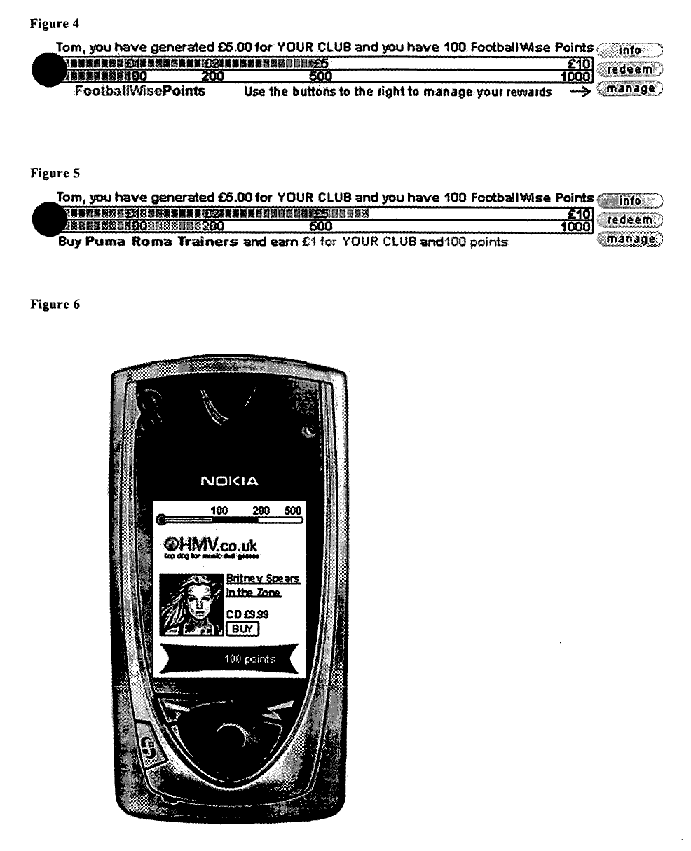

FIG. 4 shows part of a web page. In this use case, an implementation of the reward bar is described for integration into shopping pages displayed in web browsers.

The version shown here is used for anything greater than a 800 by 600 pixel resolution (which includes most modern PC and laptop monitors). Due to the high available resolution in this case, it is possible to integrate dual bars, textual information and clickable buttons into the reward bar. To display the reward bar on the HTML page, a server generated GIF or JPG image, or Macromedia Flash or SVG vector graphic is used.

In FIG. 4 the Internet Reward Bar in the balance state presents to the consumer
In the upper bar, the monetary amount generated by their purchases for their chosen beneficiary organisation (in this case, the Football Club which they support); and
In the lower bar, the number of reward points they currently hold
   In the internet reward bar presented in FIG. 5, the reward bar has switched to the active browse state because a consumer has clicked on a given product in a product in a product list on a website, or a link referring to the product in a promotional email.

In FIG. 5 the internet reward bar in the balance state presents:
In the upper bar, the monetary amount generated by their purchases for their chosen beneficiary organisation (in this case, the Football Club which they support; and
In the lower bar, the number of reward points they currently hold.

Moreover, since the consumer has clicked a product (in this case “Puma Roma Trainers”) and the bar has instantly changed so that the consumer can now additionally see:
In the upper bar, the increase in beneficiary contribution amount that the current potential purchase would generate, in lighter shading or a different colour;
In the lower bar, the extra reward points that the current potential purchase would generate, in the same lighter shading or different colour; and
Below the lower bar, a textual confirmation of the product being examined and the potential rewards available
   WAP Implementation

In FIG. 6, an implementation of the reward bar is described for integration into shopping pages displayed in WAP browsers.

In FIG. 6, the consumer is browsing a WAP site on a mobile phone; the reward bar is shown in the active browse state. The consumer can see:—
the current reward point balance in the reward bar; and
the increase in reward point balance that the current potential purchase would generate.
A banner is also provided with textual confirmation of the graphical indicator.

One of the advantageous of invention embodiments is that a client can use multiple devices.

For example:

The consumer checks his reward balance on his mobile telephone (using a WAP site)

The consumer purchases some cinema tickets manually from a participating cinema (merchant) while he is out, which increases his reward balance.
Returning home and using the internet on his home computer on a participating shopping site, he sees his reward bar has been updated, and he now has enough points to obtain a free ticket to a football match.
He clicks the reward bar and is taken to a page where he redeems his points for the ticket.

Checking his phone, he again notes the reward bar has been set to zero.

Point of Sale and Back Office Transactions

A shopping transaction within the loyalty scheme can be conceived of as two logically sequential parts which will be referred to as a point of sale transaction and a back office transaction.

A point of sale transaction involves the systems which present the reward program in a way that encourages consumer spend, calculating in real time such revenue splits as are necessary for this purpose (i.e. the amount that will be contributed as a consumer reward and to the selected beneficiaries). For each such transaction there is a corresponding back office transaction which calculates such things as revenue splits amongst the remaining parties involved and ultimately feeds net settlement instructions into the banking network. The associated back office transaction may occur as part of, immediately following or some time after a point of sale transaction.

Point of Sale Transactions

FIG. 7 shows the key logical entities involved in a point of sale transaction under a preferred embodiment of the loyalty scheme. It is required that the entities make use of a communications network to exchange information in real time. The information which needs to be accessed for each transaction is broken down into consumer, reward and product data, i.e. the identity and consumer record of the consumer involved in the transaction; the reward status of the consumer; and the details of the product including the associated rewards offered for a purchase of that product.

At the highest level, the entities involved are the consumer 1; a device 2 on which loyalty information can be displayed and possibly interacted with; a system 3 which presents products to the consumer (run by the loyalty provider or merchant); a merchant system 4 which is used by the merchant to manage their products; a loyalty system 5 run by the loyalty provider which manages and allocates rewards; and a consumer bank 6 which is accessed for real time fund authorization.

The consumer 1 is physically or virtually present in a shopping environment (either in a retail store or browsing on an electronic device). H is loyalty device 2 indicates his current accumulated loyalty status. The consumer begins to examine a product using whatever product presentation 3 the merchant 4 or loyalty provider 5 has provided (such as a web page). Immediately the potential loyalty reward that would be obtained for purchasing the product is retrieved from the loyalty provider 5 and displayed on his loyalty device. This reward is personalized and is generated by the loyalty provider system in response to arbitrary complex rules involving the consumer, merchant and product in question. When the consumer confirms the order (which may consist of a number of purchase in a virtual “shopping basket”), payment authorisation and/or capture is usually made against the consumer's bank (in practice via an intermediary “payment service provider”). Details of internet payments and intermediaries are well known to the skilled person in the art.

The presentation layer 3 in FIG. 7 handles the direct connection to the consumer's device which presents the point of sale interface. In the case of web pages, this can be handled by the merchant's own web servers or by web servers managed by the loyalty provider. In either case, servers from both parties must communicate across a network (e.g. the public Internet or a private point to point link) in order to generate the full page to return to the client. That is, the loyalty provider will generally hold loyalty information and consumer information and calculate loyalty points and donation levels. The merchant will generally hold product information. However, this is an illustrative embodiment and one system may hold all information if expedient. For example, the loyalty provider may host a website for the merchant which has full loyalty functionality. Equally a large merchant may wish to “buy in” an entire loyalty provider specific to that merchant system.

FIGS. 8 and 9 show alternative ways that a shopping transaction at the point of sale can be executed according to whether the merchant (FIG. 8) or the loyalty provider (FIG. 9) generates the web page.

Merchant Presentation

In the case of merchant presentation shown in FIG. 8, it is the individual's reward data that is transferred between back end servers across the network. When the consumer clicks 11 the product, the merchant web servers request 12 and retrieve 13 loyalty information such as the reward bar directly from the loyalty provider's back end servers and integrate it into the page which is returned 14 to the consumer.

Loyalty Provider Presentation

In the case of loyalty provider presentation in FIG. 8 when the consumer clicks the product 21, it is the product data that is transferred 22, 23 between the back end servers across the network. In this case, the product details (e.g. a product image, descriptive text, terms & conditions) are requested from the merchant back end servers by the loyalty provider's web servers in real time and the loyalty provider web server then passes 24 this information to the consumer with the loyalty information. As a performance optimisation, the loyalty provider architecture can cache this data in a database, to avoid constant use of the back end connection.

Alternatively, the merchant product catalogue can be replicated to the loyalty provider database.

Loyalty Provider Database

The Loyalty Provider database may provide the following records;
Consumer session data—keeping track of when and how long individuals access the site, login, which products and promotions they view;
Consumer registry data—recording consumer's personal data (addresses, credit cards, marketing info);
Merchant and beneficiary registry data—legal records, VAT numbers, etc;
Products and deals—maintaining catalogue of data from multiple merchants; and
Orders, payments (points and currency)—transactional data, beneficiary contributions.

The consumer session, consumer registry and products and deals information may be used to provide personalized promotional content and to feed into a CRM (customer relationship management software package as known in the art). For example, a customer's order history and login habits as well as loyalty points and/or donation levels could be used to construct a profile for offering additional reward points.

Back Office Transaction

FIG. 10 shows the key logical entities involved in a back office transaction under the loyalty scheme. It is not necessarily required that the entities make use of a real time communications network to exchange information. The back office transactions are managed primarily by updates within the loyalty provider database, and by messages exchanged between the loyalty provider and the banking network.

Where direct back office communication between provider and merchant, or between provider and beneficiary, is not possible for technical reasons, transactions can be reconciled for accounting purposes by other means such as printed reports.

At the highest level, for a given full transaction revenue split calculation (depends on many factors such as price, product, location, promotion, merchant, etc), the entities involved are the loyalty provider system 5; the consumer's bank 6; the beneficiary's bank 7; the merchant's bank 8; and the loyalty provider's bank 9.

Monetary payment has usually already been collected from the consumer's bank 9 as part of the point of sale transaction. In the back office transaction, this payment revenue and/or any points redeemed by the consumer are distributed to the parties involved. This involves updating the party's points balance in the loyalty provider database and/or transferring money into the banking network. Usually the latter settlement will be performed in arrears on an aggregated batch basis.

As mentioned in the introduction, loyalty points are a form of currency, and hence transaction payments to any party within the system can be partially or fully made in points. The loyalty scheme allows merchants or beneficiaries to retain income in the system as a points balance which can be redistributed as required, for example to consumers as promotional discounts. Similarly, consumer points balances can be transferred to the consumer's registered bank or used to pay for goods.

Brand Labels and Web Brands

Any deal is purchased through a particular web brand of a web site. Different brands of the same site provide a different look and feel for what is essentially the same site underneath. For example, www.footballshop.com is a “white label” version of a shopping site, but and footballclub.footballshop.com and Clothingbrand.footballshop.com may be a cut-down version of the same site (for purchase of goods corresponding to the football club or clothing brand. Thus these are web brands of a single site (or family of sites) called “footballshop”.

In addition to having a manufacturer defined (such as Nike or Adidas), any product can optionally have a brand label. This has nothing to do with a web brand discussed above. A brand label identifies a commercially sensitive product association, often to a beneficiary. For example, if the beneficiary is a football club, there may be a wide range of products sold through different outlets from different manufacturers which are associated with the club's brand label (e.g. Redskins, Manchester United) by colour, use of the club's logo etc.

Orders and Deals

FIG. 11 shows a revenue split mechanism for purchases in an order potential including special offers for certain combinations of products (known as combo deals).

The consumer places an order, which consists of multiple order items, each potentially provided by different merchants if the web page used is generated by the loyalty provider. When purchasing each order item, the system will have displayed the best available corresponding deal. A deal can be either a base deal or a combo deal. Each base deal has a corresponding base price and base points allocation. A combo deal is a special offer created by a merchant and is a combination of base deals with extra pricing and reward rules applied.

Example of simple combo deals are:
“buy product X and get product Y half price”
“buy 2 product X and get the third free”
“buy product X and product Y and get 100 additional reward points”

Combo deals can actually reference an arbitrary number of base deals in complex ways although in practise a combo deal should be kept simple so as not to confuse consumers.

The loyalty provider or merchant system automatically calculates whether a combo deal applies to a transaction and, if the consumer agrees, uses it if the deal generates an overall lower consumer price.

Revenue Splits

The system allows an unlimited number of “revenue split” records. A revenue split record specifies a list of counterparties and percentage currency and points amounts for each. Revenue splits are mapped at the base deal level.

This design of schema effectively means that the revenue from the sale of any given product in the system to any given merchant can be allocated arbitrarily to different parties and in different amounts and forms.

Execution Architecture

FIG. 12 shows the important modules and classes in the loyalty scheme execution architecture and indicate, how requests are handled and pages served. The architecture is embodied in Java code here and could be used for any websites. The command class models a consumer clicking a link on a web page or an automatic incoming remote request. Every command has its own command proxy class which checks if the remote consumer has authorization to execute the command, validates the input parameters and if successful then executes the command.

The business components are implemented as modules which use system services like database access and session management.

The architecture handles the page generation and content delivery for all the different websites that are required for the loyalty scheme.

Implementation of an Embodiment of the Reward Bar

The following description relates primarily to a system hosted by a loyalty provider, which has the necessary processing, storage and data transfer/sharing capabilities to run a loyalty scheme as described herein.

Firstly, a number of tables are described which combine to provide the necessary information to calculate reward points and donations for the consumer based on purchases over the internet.

Allocating Points to Deals

A merchant sets up a deal in the loyalty provider's database either manually (using the merchant site web pages provided by the loyalty provider) or automatically (using a direct back office feed into the loyalty provider's systems).

The simplest deal set up process involves the merchant specifying the price, tax and delivery amounts, as well as the basic number of loyalty points to offer the customer (if any). This points value is stored on a BaseDeal table.

The merchant can allocate extra points by using combo deal rules (e.g. “buy 2 product A and get 100 extra points”). This extra points allocated is stored on a ComboDeal table, and can be specified as a fixed number of points or a percentage of the current total base points for the order.

Association of Merchant Goods with Web Brands

To prevent conflicts of interest, there must be flexibility in forming commercial deals with beneficiaries. The beneficiary itself is often a merchant that offers products for sale through its own web brand (that is a website in its incarnation representing the beneficiary) and possibly through other generic brands also.

In a system serving many consumers, beneficiaries and merchants, there will often be merchants whose products should not be offered for sale through certain web brands. To enforce this, a merchant must be associated with a web brand on a MerchantBrand table for its products to be listed on that brand site. The MerchantBrand table links merchants to web brands.

Determining the Beneficiary

When a transaction is performed, the beneficiary is determined from a BeneficiaryRule table. Hereinafter * in a table indicates “match anything”

| Web Brand | Brand label | Beneficiary |
|---|---|---|
| * | Redskins | Redskins |
| www.footballshop.com | * | None |
| Redskins.footballshop.com | * | Redskins |

The table indicates an example set up.

Row 1 says “the beneficiary is Redskins for any Redskins branded products sold through any web brand”

Row 2 says “there is no beneficiary for any products sold through www.footballshop.com web brand”

Row 3 says “the beneficiary is Redskins for all products sold through the Redskins web brand”

The matching rules are applied in order (i.e. Row 1 overrides Row 2 etc).

Defining Revenue Splits

For a given transaction, the gross sum is split according to a distribution specified on a RevenueSplit table. In the example below, the TEN_FIVE rule specifies that 10% of the gross proceeds are to be allocated to the beneficiary, and 5% to the system as a charge for the loyalty scheme. The remainder is allocated to the vendor/merchant.

| | | | Beneficiary | |
|---|---|---|---|---|
| Name | Beneficiary % | System % | fixed | System fixed |
| ZERO_FIVE | 0 | 5 | 0 | 0 |
| TEN_FIVE | 10 | 5 | 0 | 0 |

The revenue split table also allows a fixed charge instead of or in addition to a percentage charge.

Determining the Revenue Split Dynamically

Once payment confirmation has been received for a given transaction, a correct RevenueSplit needs to be chosen. The particular split chosen can depend on: who the vendor merchant is, the class of product and who the beneficiary is

These rules are defined (again matched in order) on a RevenueSplitRule table.

| Vendor Merchant | Product Class | Beneficiary | Revenue Split |
|---|---|---|---|
| Redskins Football | Tickets | Redskins | ZERO_FIVE |
| Tickets LLC | | | |
| * | Tickets | System | ZERO_FIVE |
| * | Tickets | Redskins | TEN_FIVE |

In this example, a company called “Redskins Football Tickets LLC” is charged only a 5% system fee for selling tickets where Redskins is the beneficiary. Any other merchant selling such tickets is charged 15%, 10% to Redskins and 5% System fee.

Applying Points Transactions

For a given order, the number of points awarded to the customer, say P, is calculated as the sum of the base points for the base deals in the customer's order, with the addition of any extra points specified on any combo deals that may apply. There is an entry on an AccountTransaction table which has the effect of a debiting the vendor merchant account by P points and crediting the consumer account with P points. The points balance on an AccountBalance table is updated for both accounts.

Thus any consumer's current points balance is retrieved with a simple lookup on the AccountBalance table.

When it comes to the periodic settlement cycle with the merchant, the settlement payment will be made to the merchant for the currency value of their sales after revenue split charges (donation, system changes, loyalty points (?)) have been deducted and after the currency value of the merchant's points balance has been deducted.

The currency value of reward points is specified on a RefCurrencyFx table.

| Currency1 | Currency2 | FX Rate |
|---|---|---|
| POINTS | USD | 0.05 |
| POINTS | EUR | 0.07 |

Recording the Consumer Revenue Contribution

After the revenue split is computed, the various required transactions are entered to reflect this on the AccountTransaction table. For any transaction where a beneficiary is involved, the entry on a UserContribution table is updated as shown below.

| User | Beneficiary | Amount | Currency | Entry Date |
|---|---|---|---|---|
| John Smith | Redskins | 3.45 | USD | 2004-01-19 |
| John Smith | Redskins | 14.00 | USD | 2004-04-29 |
| John Smith | System | 0.10 | USD | 2004-05-29 |

The total contribution from any given consumer is therefore computed by a simple aggregate sum function on the UserContribution table, and can be restricted by date range to answer such queries as “how much did consumer X raise for beneficiary B in January 2004?”. Let this value be referred to as “EARNED_ALREADY_MONEY”.

Including the Reward Bar

This section discusses the case of presenting the reward bar to a web browser using HTML for which embodiments of the present invention use JSP JSTL as the templating technology.

As discussed previously (Loyalty Provider Presentation vs Merchant Presentation), the reward bar can be embedded in a page locally or remotely. The JSP JSTL specifications enable the included fragments to be retrieved from a remote server.

Sample code imported for including the reward bar remotely from a merchant hosted page using JSTL is shown below:

<%@ taglib prefix=“c” uri=“http://java.sun.com/jstl/core_rt” %>
some merchant html content...
<c:import url=“http://www.footballshop.com/
rewardBar?pid=123&pid=124”/>
some more merchant html content below the reward bar...

details on products 123 and 124

Sample code for including the reward bar in a locally hosted page using JSP is given below:

<%@ taglib prefix=“c” uri=“http://java.sun.com/jstl/core_rt” %>
some system html content...
<% pageContext.include(FRAGMENT_REWARD_BAR) %>
some more system html content...

Generating the Reward

The reward bar itself can be customized to have any HTML look and feel. Some different examples have already been given. The example Reward Bar discussed here is a two bar display indicating
i) the amount of money raised by the consumer for the beneficiary as read from the UserContribution table.
ii) the customer's current points balance as read from the AccountBalance table.

The key element is an HTML <div> element with id “progressBar” and “pointsBar”.

```
<script>
updateBarEarned( EARNED_ALREADY );
</script>
<table width=“587” cellspacing=“0” cellpadding=“0” height=“52”>
  <tr>
    <td width=“211” height=“16” align=“left”
      rowspan=“2” valign=“middle”>
<a href=“#”><img src=“../../../images/common/btn_info.gif” ></a>
<a href=“#”><img src=“../../../images/common/btn_collect.gif” ></a>
<a href=“#”>
<img src=“../../../images/common/btn_manage.gif” ></a>
  </td>
  <td width=“376” height=“16” valign=“top”>
    <div id=“progressBar”></div>
    <div id=“pointsBar”></div>
  </td>
  </tr>
</table>
```

The loyalty provider server generating the Reward Bar fragment supplies the value of the EARNED_ALREADY Javascript variable. When the browser loads the page, it is told to call the updateBarEarned( ) Javascript function which extends the progress bar to the value calculated by the server from the UserContribution table (after scaling—see below). The POINTS_ALREADY value is used in a similar way to initialize the points bar.

Scaling the Reward Bar

The Javascript variable PRODUCT_124 contains a value which represents the normalized number of squares to append to the bar for that specific product and consumer. The name of this variable is always “PRODUCT_” followed by the product id (e.g. 123, 124, etc).

The Reward Bar is dynamically scaled to indicate a maximum amount which is close to double the individual consumer's total contribution so far, being conveniently rounded. This value is referred to as REWARD_BAR_MONEY_MAX.

If a page contains details on a particular product, say product 124, then using the rules described above (depending on the beneficiary, the brand, the brand label, the merchant etc) the contribution for purchasing the associated deal is calculated as PRODUCT_124_MONEY.

The Javascript variables in this case are then easily computed:

EARNED_ALREADY = round( (EARNED_ALREADY_MONEY /
REWARD_BAR_MONEY_MAX) * 40 )
PRODUCT_124 = round( (PRODUCT_124_MONEY /
REWARD_BAR_MONEY_MAX) * 40 )

If desired a given site can also scale the Reward Bar based on the value of the deal, e.g. PRODUCT_124_MONEY. This can be helpful if the site sells products of widely varying value, although the downside is that the consumer may become confused if the scale varies for each product they click on.

The same principle is used to scale the points bar.

Manipulating the Reward Bar Dynamically

In this example the Reward Bar “thermometer” itself is made of up to 40 small square images in a horizontal line. The images can be red images for money already earned for the beneficiary and orange for potential new earnings.

The updateBarEarned( ) function calls the addToBar( ) function to add the appropriate number of red squares to the blank bar when the page is first loaded.

The following code corresponds to a single bar Javascript function

```
/*************************************
points functions for single thermo bar.
*************************************/
function updateBarEarned(points){
    addToBar(‘red’, points);
}
function updateBarExtra(points){
    if( EARNED_ALREADY + points > 40 ) {
        points = 40 − EARNED_ALREADY;
    }
    addToBar(‘orange’, points);
}
function clearBarExtra( ) {
    var nodes = document.getElementById(‘progressBar’).childNodes;
    for (var i=0;i<nodes.length;i++) {
            if (nodes.item(i).className == ‘extraPoints’){
                nodes.item(i).style.display = ‘none’;
            }
      }
}
function addToBar(whichColour,points){
    var htmlString = “”;
    var spanClass;
    if (whichColour == ‘red’){
        spanClass = “ earnedPoints”;
    }
    else if (whichColour == ‘orange’){
        spanClass = “extraPoints”;
    }
    for( i=0; i<points; i++) {
        htmlString = htmlString +
        “<span class=\“” + spanClass + “\”>
          <img src=‘images/common/square_” +
            whichColour +“.gif’></span>”;
    }
    var now = document.getElementById(‘progressBar’).innerHTML;
    document.getElementById(‘progressBar’).innerHTML = now +
    htmlString;
}
```

Interacting with the Reward Bar in Event Handlers

When the consumer moves the mouse over any item on the page (e.g. a product image displayed in a list of products on a catalogue page) the updateBarExtra( ) function is called in a Javascript on MouseOver event handler. Thus the Reward Bar instantly flicks up by the amount specified for that product. When the consumer's mouse moves away from that particular product the on MouseOut event calls the clearBarExtra( ) function to remove the orange squares again.

<a href=“/somemerchant/buyproduct?id=124”
onMouseOver=“updateBarExtra(PRODUCT_124);”
onMouseOut=“clearBarExtra( );”>Generate 5 GBP for Redskins when
you purchase this product!!</a>

The bar functions operate by looking up the progressBar <div> and appending to its DHTML element property “innerHTML”. The same principle is used to scale the points bar.

Whilst the invention has been described with reference to specific embodiments, the reader will appreciate that it is not so limited, being defined by the scope and spirit of the following claims.

The invention can be implemented in digital electronic circuitry, or in computer hardware, firmware, software, or in combinations of them. The invention can be implemented as a one or more computer program products i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand along a program or as a module, component, subroutine, or other unit suitable for use in a data processing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on inputs data and generating output. Apparatus of the invention can be implemented as a programmed computer or as special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions coupled to one or more memory devices for storing instructions and data.

The components of the loyalty scheme can be interconnected by any form or medium of digital data communication, e.g., a communication network. Examples of communication networks include a local area network (“LAN”), a radio network (“RAN”) and a wide area network (“WAN”), e.g., the Internet.

The invention has been described in terms of particular embodiments. Other embodiments are within the scope of the following claims. For example, the steps of the invention can be performed in a different order and still achieve desirable results.

1. A computer implemented method of generating income for a beneficiary organisation and loyalty points using purchases by a consumer, including the steps of:
whenever a purchase is made, allocating the consumer corresponding loyalty points and a separate donation to be transferred to the beneficiary organisation;
accumulating the consumer's allocated loyalty points and donation with those of purchases already made; and
generating a visual accumulated indicator of the consumer's accumulated loyalty points and/or donation for display to the consumer over a communications network.

2. A loyalty provider computer system for generating income for a beneficiary organisation and loyalty points using purchases by a consumer, including functionality for:
whenever a purchase is made, allocating the consumer corresponding loyalty points and a separate donation to be transferred to the beneficiary organisation;
accumulating the consumer's allocated loyalty points and donation with those of purchases already made; and
generating a visual accumulated indicator of the consumer's accumulated loyalty points and/or donation for display to the consumer over a communications network.

3. A method according to claim 1 wherein the purchase is made over the communications network.

4. A computer implemented method of generating income for a beneficiary and/or loyalty points under a loyalty scheme using purchases by a consumer, including the steps of
using loyalty points and/or donation amounts allocated according to the purchases by: whenever a potential purchase decision is indicated by the consumer, generating for display to the consumer a real-time visual potential indicator of potential loyalty points and/or potential income that would be awarded if the purchase were made; and
whenever a purchase is made, awarding the consumer loyalty points and/or a separate generated donation to be transferred to the beneficiary organisation; and
generating for display to the consumer in real-time an accumulated visual indicator of his accumulated loyalty points and/or donations.

5. A loyalty provider computer system for generating income for a beneficiary and/or loyalty points under a loyalty scheme using purchases by a consumer, including functionality for using loyalty points and/or donation amounts allocated according to the purchases by:
whenever a potential purchase decision is indicated by the consumer, generating for display to the consumer a real-time visual potential indicator of potential loyalty points and/or potential income that would be awarded if the purchase were made; and
whenever a purchase is made, awarding the consumer loyalty points and/or a separate generated donation to be transferred to the beneficiary organisation; and generating for display to the consumer in real-time an accumulated visual indicator of his accumulated loyalty points and/or donations.

6. A method according to claim 4 wherein the method includes display over a communications network of the visual potential and accumulated indicators.

7. A method according to claim 4 wherein the visual accumulated and/or potential indicators comprise a graphical display element.

8. A method according to claim 7 wherein the graphical display element includes a reward bar comprising one or more individual bars, each bar comprising one or more blocks, the size of one block in one dimension corresponding to loyalty points or donations information for a consumer.

9. A method according to claim 4 wherein the consumer indicates a potential purchase by moving a mouse over the product on a webpage, clicking on a link to a product or holding a smart card against an electronically identified product.

10. A method according to claim 9 wherein the appearance and functionality of the reward bar can be dynamically varied depending on the capabilities of the user agent running in the consumer's loyalty device.

11. A method according to claim 7, wherein the graphical display element includes both a visual accumulated indicator having one display attribute, and a visual potential indicator having a different second display attributes.

12. A method according to claim 7, wherein the graphical indicator has labelling, such as numbering in points and/or a currency to give the consumer a more accurate impression of loyalty points/donation level.

13. A method according to claim 8, wherein the reward bar is automatically scaled according to the actual figures for donation amount and/or loyalty points accessed over the communication network.

14. A system according to claim 5, wherein the visual indicator is generated securely in real time for display over a communications network from a set of central servers managed by the loyalty provider.

15. A loyalty provider computer system according to claim 5, wherein the system creates shopping webpages for display of goods available from one or more merchants under the loyalty scheme and the potential and accumulated indicators are provided as part of the shopping webpage.

16. A loyalty provider computer system according to claim 5, wherein the system creates a signal carrying code which provides a display element including the potential and accumulated indicators for inclusion in shopping webpages hosted by one or more merchants offering goods under the loyalty scheme.

17. A merchant computer system for connection to a loyalty provider computer system over a communication network, wherein the merchant system is operable to provide information on purchases for display to a consumer over the network,
calculate loyalty information corresponding to a potential purchase indicated by the consumer and/or retrieve such information from the loyalty provider system; and
provide this loyalty information to the consumer over the network in real time for any potential purchase decision.

18. A merchant computer system according to claim 17, wherein the loyalty information calculated or retrieved by the merchant system includes a graphical display element showing potential loyalty points and/or donations to a beneficiary.

19. A method according to claim 4, wherein the merchant of the product can influence the reward points for each purchase using the loyalty provider computer system or a merchant computer system to set up consumer deals.

20. A method according to claim 19, wherein one or more elements of marketing data that are known about the consumer in the loyalty provider computer system can be used as the basis for offering selective rewards, either by the loyalty provider or by the merchant.

21. A method according to claim 19, wherein the donation and/or loyalty points are determined individually for each purchase according to the parties involved.

22. A method according to claim 4, wherein the donation level is determined as a percentage of the purchase price for each purchase and a percentage of the purchase price is also allocated to the loyalty provider as payment for provision of the loyalty scheme.

23. A method according to claim 22, wherein the percentages allocated to the donation and loyalty provider are defined according to the merchant, the beneficiary organisation specified (if any) and/or the product class.

24. A method according to claim 4, wherein the consumer makes payment for the purchase to a loyalty provider who manages the loyalty scheme and the loyalty provider settles with the beneficiary organisation and merchants providing the goods periodically, wherein settlement to the merchant is made once a currency value of a consumer's redeemed loyalty points, a loyalty scheme charge and any donation have all been deducted.

25. A method according to claim 4, wherein loyalty points can be redeemed against any purchase from any merchant made under the loyalty scheme alone, or in conjunction with monetary payment.

26. A method according to claim 4, wherein redemption of loyalty points is invisible to the merchant.

27. A method according to claim 4, wherein the consumers accumulated donations are used to generate a consumer league table for display over a communications network.

28. A method according to claim 27, wherein the beneficiary awards a prize to a consumer at the top of the league table.

29. A signal carrying code which when read by a browser creates a consumer webpage used for generating income for a beneficiary organisation and loyalty points using purchases by a consumer, wherein the webpage, when accessed, allows award to the consumer of loyalty points and a donation to the beneficiary organisation corresponding to the purchase; and
display to the consumer of a visual indicator showing accumulated loyalty points and/or income generated; and
optionally redemption of the loyalty points by the consumer.

30. A signal carrying code which when read by a browser creates a consumer webpage allowing display of loyalty points for a consumer and/or donations for a beneficiary organisation according to purchases by the consumer, wherein the webpage, when accessed, allows
retrieval from a server of accumulated visual indicator showing the consumer's previously accumulated loyalty points and/or donations;
display of the accumulated visual indicator;
highlighting of a potential purchase by the consumer;
retrieval from a server of a potential visual indicator showing potential loyalty points and/or donations; and
display of the accumulated and potential visual indicators.

31. A signal according to claim 30 wherein the webpage, when accessed, allows acquisition of a purchase by a consumer.

32. A signal carrying code which when rendered, produces a display element for use on a consumer device with a display and a connection in use to a communication network through which connection data on purchases and associated loyalty points and donation amounts can be accessed, wherein the display element includes a visual indicator of the consumer's loyalty points and/or donation generated, the visual indicator being downloadable from the communication network.

33. A method of producing a signal according to claim 32 for provision to a consumer over a communications network.

34. A computer program product tangibly embodied in an information carrier to control operation of a data processing apparatus and thereby provide the system of claim 5.

35. A computer program product tangibly embodied in an information carrier which, when run on a data processing apparatus having a database product and an application server carries out the method according to claim 4.
